(19) United States
(12) Patent Application Publication
(10) Pub. No.: US 2025/0349933 A1
(43) Pub. Date: Nov. 13, 2025

(54) TEMPERATURE CONTROL SYSTEM FOR ENERGY-STORAGE BATTERY AND STORAGE SYSTEM

(71) Applicant: Dynapack International Technology Corporation, Taoyuan City (TW)

(72) Inventors: Wen-Chin LIAO, Taoyuan City (TW); Tsan-Lun HSU, Taoyuan City (TW)

(73) Assignee: Dynapack International Technology Corporation, Taoyuan City (TW)

(21) Appl. No.: 18/659,508

(22) Filed: May 9, 2024

(51) Int. Cl. H01M 10/6568; H01M 10/613; H01M 10/63; H01M 10/6551; H01M 50/24; H01M 50/244; H01M 50/636

(52) U.S. Cl. CPC H01M 10/6568; H01M 10/613; H01M 10/63; H01M 10/6551; H01M 50/24; H01M 50/244; H01M 50/636; H01M 2200/10

(57) ABSTRACT

A temperature control system for energy-storage battery includes a fluid storage cabinet internally divided into non-communicable liquid circulating space and storage compartments for holding a temperature control liquid and a plurality of battery modules, respectively. The liquid circulating space communicates with input and output pipes of a temperature control module, so that the temperature control liquid circulates between the fluid storage cabinet and the temperature control module. The temperature control liquid undergoes a heat exchange in the temperature control module to reach a first temperature and undergoes another heat exchange in the fluid storage cabinet to reach a second temperature. Since the battery modules are not in direct contact with liquid, they need not be sealed and are therefore less complicate and expensive. Further, with a large equivalent liquid provided therein, the temperature control system provides stable environmental temperature control to upgrade heat exchange effect of the battery modules.

### FIELD OF THE INVENTION

The present invention relates to an immersion type temperature control system for energy-storage battery, and more particularly, to an energy-storage battery temperature control system that enables fast heat exchange by isolating a plurality of battery modules from a large equivalent temperature control liquid.

### BACKGROUND OF THE INVENTION

Presently, there are two types of temperature control techniques for energy storage systems, the first of which uses gas to cool the energy storage systems, and the second of which uses liquid to cool the energy storage systems. In the conventional gas cooling, either natural air convection or forced air convection can be used. However, the conventional air cooling has limited cooling efficiency. In addition, passages for airflow would be largely compressed with the increasing of the energy density of the energy storage systems, such that the gas cooling type energy storage systems could not to provide effective temperature control under this condition.

As to the conventional liquid cooling, it can be a cold plate technique for dissipating heat indirectly, or a battery immersion technique for dissipating heat directly. The cold plate technique requires additionally provided cold plates and pipelines for transferring the cooling liquid to thereby increase the complexity and manufacturing cost of the energy storage systems. In the battery immersion technique, battery cells are directly immersed in the cooling liquid to save the cold plates and the cooling liquid pipelines. However, the cooling liquid for use in the battery immersion technique must satisfy relatively high performance requirements, it must be electrically non-conductive and non-flammable, and is therefore very expensive to cause largely increased cost of the energy storage systems.

Further, in the event of thermal runaway, the existing energy storage systems usually need additional fire fighting equipment outside the energy storage systems, such as water resource, aerosol or gas (e.g. FM-200 and Novec 1230), to avoid further damages and losses of the energy storage systems. However, the provision of additional fire fighting equipment for the energy storage systems would inevitably cause rapidly increased cost for constructing the energy storage systems, and it is not assured whether the fire fighting equipment is absolutely failure and trouble free or not.

### SUMMARY OF THE INVENTION

A primary object of the present invention is to provide an energy-storage battery temperature control system that isolates battery modules from direct contacting with a large equivalent temperature control liquid to enable largely reduced complexity and cost in battery module design; and the large equivalent temperature control liquid also provides stable environment temperature control to upgrade the heat exchange effectiveness of the battery modules.

Another object of the present invention is to provide an immersion type energy-storage battery temperature control system, of which a large equivalent temperature control liquid can be used directly as a fire inhibitor in case of thermal runaway. With the energy-storage battery temperature control system of the present invention, no other additional design for a fire fighting system is needed, and the temperature control liquid immersing the battery modules can be directly used to prevent the propagation of thermal runaway.

A further object of the present invention is to provide an energy-storage battery temperature control system, of which a closed liquid circulation design cooperates with swirling flow passages formed by a plurality of radiating fins for easily and quickly carrying away heat from the battery modules, which are spontaneous heat sources. Therefore, the battery modules cool down quickly without the need of additional water cooling parts.

A still further object of the present invention is to provide an energy-storage battery temperature control system, according to which battery modules and temperature control liquid are isolated from each other. Therefore, the temperature control liquid is not necessarily to be a special solution such as a non-conductive or a non-corrosive solution but can instead be other easily available liquids, such as a coolant, pure water or rainwater, enabling convenient replacement or obtaining of the temperature control liquid for the energy-storage battery temperature control system to largely reduce the operating cost thereof.

A still further object of the present invention is to provide a storage system for storing dangerous objects other than battery modules to provide necessary management control of the dangerous objects. In the case of any dangerous condition that is out of control, the immersion of the dangerous objects in the temperature control liquid in the storage system facilitates stopping the dangerous condition from becoming more serious.

To achieve the above and other objects, the temperature control system for energy-storage battery according to the present invention includes a fluid storage cabinet, a plurality of battery modules, a temperature control module, and a temperature control liquid. The fluid storage cabinet includes a plurality of front openings and a plurality of storage chambers communicable with and located in one to one correspondence to the front openings, such that the fluid storage cabinet is internally divided into a liquid circulation space and a plurality of storage compartments not communicable with the liquid circulation space.

The battery modules respectively include a battery main body and a closing cover connected to the battery main body. Every battery main body is removably plugged into one of the storage chambers and the closing cover seals the front opening of the storage chamber, such that the battery main body is in contact with all conductive wall surfaces of the storage chamber.

The temperature control module includes an input pipe and an output pipe communicable with the liquid circulation space, and a temperature controller connected to between the input pipe and the output pipe. The temperature control liquid is filled in the fluid storage cabinet to flow through the liquid circulation space, the input pipe, the temperature controller, and the output pipe.

The temperature control liquid undergoes a heat exchange when flowing through the temperature controller to thereby reach a first temperature, and undergoes another heat exchange when flowing through the fluid storage cabinet to thereby reach a second temperature; and thereafter, the temperature control liquid flows through the temperature controller again to undergo a heat exchange thereat and reach the first temperature again.

The temperature control system for energy-storage battery further includes a circuit control module, which is assembled on an outer surface of the fluid storage cabinet and includes a control box and a plurality of conductors; and the storage chambers and the control box are electrically connected by the conductors.

The fluid storage cabinet further includes a plurality of radiating fins and a circulation pump. The radiating fins are distributed on outer wall surfaces of the storage chambers to provide increased heat dissipation areas, and the circulation pump is installed in the liquid circulation space for changing the temperature control liquid to different flow speeds.

In a preferred embodiment, the radiating fins are arrayed in the liquid circulation space to form a flow passage, such that the temperature control liquid in cooperation with the flow passage and the circulation pump form a swirling flow in the liquid circulation space.

The radiating fins have a first part that is distributed between any two adjacent storage chambers to form a plurality of supporting spoiler zones, and a second part that is distributed on sidewall surfaces of the storage chambers to form a plurality of guiding spoiler zones; and the guiding spoiler zones and the supporting spoiler zones are arrayed alternately to form the flow passage.

The temperature control system for energy-storage battery further includes a plurality of breaking devices, each of the breaking devices is provided on at least one of the storage chamber and the battery module for breaking one conductive wall surface of the storage chamber, such that the temperature control liquid flows from the liquid circulation space into the storage compartment to contact with the battery modules and inhibit thermal runaway of the high temperature battery.

Four operable configurations are available for the breaking devices. In the first configuration, the breaking device includes a sealing cap disposed on the battery main body and a slitted weak wall portion formed on the storage chamber. The battery main body would burst out an amount of electrolyte in the event of battery cell abnormality, and the electrolyte has a temperature high enough to melt the sealing cap and the slitted weak wall portion, so that a liquid-in hole is formed on the conductive wall surface for allowing the temperature control liquid to flow into the storage chamber.

The breaking device in the second configuration includes a pointed breaking element provided on the battery main body; the pointed breaking element includes a plurality of radially alternately arranged oblique conical sections and flutes, and the oblique conical sections and flutes together form a cone with a piercing point. The battery main body would burst out an amount of electrolyte in the event of a battery cell abnormality, and the electrolyte pushes the pointed breaking element against the storage chamber to break the conductive wall surface, allowing the temperature control liquid to flow into the storage chamber via the flutes of the pointed breaking element.

The breaking device in the third configuration includes a liquid-in hole formed on the storage chamber and an isolating element for sealing the liquid-in hole. The battery main body would burst out an amount of electrolyte in the event of battery cell abnormality, and the erupted electrolyte pushes the isolating element away from the liquid-in hole, allowing the temperature control liquid to flow into the storage chamber via the liquid-in hole.

The breaking device in the fourth configuration is disposed inside the storage chamber and includes a piercing member and a sensor. The piercing member and the sensor are electrically connected to a control circuit, and the control circuit is further electrically connected to the circulation pump. The control circuit is capable of controlling the piercing member to break the conductive wall surface of the storage chamber and the circulation pump boosts the control circuit when the battery module is abnormal.

The battery modules respectively include a leakproof packing, and the leakproof packing is located between the battery module and the fluid storage cabinet. The leakproof packing is tightly clamped between the closing cover and the fluid storage cabinet when the battery module is plugged into the storage chamber via the front opening, such that the storage compartment is sealed by the leakproof packing and the closing cover to form a closed space, and the temperature control liquid flowed into the storage compartment is prevented from leaking out of the storage compartment via the front opening.

To achieve the above and other objects, the storage system according to the present invention includes a fluid storage cabinet, a plurality of storage modules, a temperature liquid, and a plurality of breaking devices. The fluid storage cabinet includes a plurality of front openings and a plurality of storage chambers communicable with and located in one-to-one correspondence to the front openings, such that the fluid storage cabinet is internally divided into a liquid circulation space and a plurality of storage compartments not communicable with the liquid circulation space. The storage modules respectively include a storage case and a closing plate connected to the storage case. The storage case is removably plugged into one of the storage chambers of the fluid storage cabinet and the closing plate seals the front opening; and the storage case is in contact with a conductive wall surface in the storage chamber and internally defines a receiving space. The temperature control liquid is filled in the liquid circulation space of the fluid storage cabinet. And, the breaking devices are respectively provided on at least one of the storage chamber and the storage module for breaking the conductive wall surface of the storage chamber, such that the temperature control liquid flows from the liquid circulation space into the storage compartment.

The storage system further includes a temperature control module, the temperature control module includes an input pipe and an output pipe communicable with the liquid circulation space, and a temperature controller connected to between the input pipe and the output pipe; such that the temperature control liquid is able to flow through the liquid circulation space, the input pipe, the temperature controller, and the output pipe to undergo a heat exchange.

The present invention has the following features: Firstly, the temperature control liquid and the battery modules are independent of and separated from each other, so that the battery modules and the temperature control liquid have a large contact area between them to largely upgrade the heat transfer effect between the battery modules and the temperature control liquid. And, radiating fins are provided on the outer wall surfaces of the storage chambers to provide increased contact area for heat exchange. Since the temperature control liquid in the fluid storage cabinet effectively removes the heat produced by the plurality of battery modules arrayed side by side, the temperature control system of the present invention has heat transfer efficiency much higher than that of conventional gas cooling technique and cold plate indirect cooling technique.

Secondly, the temperature control liquid is closed in the fluid storage cabinet and driven by the circulation pump to circulate quickly in the circulation space. Since the temperature control liquid has specific heat much higher than that of air, the temperature control system of the present invention can provide even and stable environmental temperature to facilitate good control of battery module working temperature. Further, since the temperature control liquid can evenly flow into spaces between any two adjacent storage chambers, the battery modules can be arrayed in the highest possible density to facilitate increased energy density per unit volume.

Thirdly, the temperature control module controls the temperature of the temperature control liquid in the fluid storage cabinet according to different temperature conditions. The higher volume the temperature control liquid in the fluid storage cabinet is, the less the temperature of the battery cells in the battery modules would be affected, and the more effective the heat transfer between the battery modules can be stopped.

Fourthly, in the event any of the battery modules in the energy-storage battery temperature control system is in the situation of thermal runaway, the battery cell of the battery module would burst out a large amount of high pressure gas from a relief valve thereof. The erupted gas would directly destroy the storage chamber of the battery module or drive the breaking device to destruct the sealability of the storage chamber, such that the temperature control liquid can flow into the storage chambers to completely immerse the battery module in the temperature control liquid and effectively prevent thermal runaway propagation.

Fifthly, since the temperature control liquid and the battery modules are not in physical contact in the process of heat exchanging, the temperature control liquid used in the present invention can be less expensive solutions, such as fluoride containing compounds, fluorocarbons and hydrocarbons. Alternatively, some easily available liquids, such as a coolant, pure water, or rainwater, can be directly used in the present invention to facilitate maintenance of energy-storage battery temperature control systems at remote locations.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a temperature control system for energy-storage battery according to a first embodiment of the present invention;

FIG. 2 is a partially exploded view of FIG. 1;

FIG. 3 is a fragmentary, sectional side view of the temperature control system for energy-storage battery according to the first embodiment of the present invention;

FIG. 4 is a rear phantom view of the temperature control system for energy-storage battery of the present invention;

FIGS. 5A and 5B show the manner in which a temperature control liquid flows in the temperature control system for energy-storage battery according to the present invention;

FIG. 6 shows how battery modules in the temperature control system for energy-storage battery transfer battery produced heat to the temperature control liquid via radiating fins;

FIG. 7 shows a plurality of battery modules is connected in series using a plurality of conductors of a circuit control module of the temperature control system for energy-storage battery of the present invention;

FIGS. 8A to 8D show different embodiments of a breaking device in the temperature control system for energy-storage battery according to the present invention;

FIG. 9 shows the temperature control liquid flows from a liquid circulation space into a storage compartment according to the present invention;

FIG. 10 is a perspective view of a temperature control system for energy-storage battery according to a second embodiment of the present invention;

FIG. 11 is a sectional side view of FIG. 10;

FIG. 12 shows the manner in which the temperature control liquid flows in the temperature control system for energy-storage battery according to the second embodiment of the present invention; and

FIG. 13 is a sectional view of a storage system according to the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

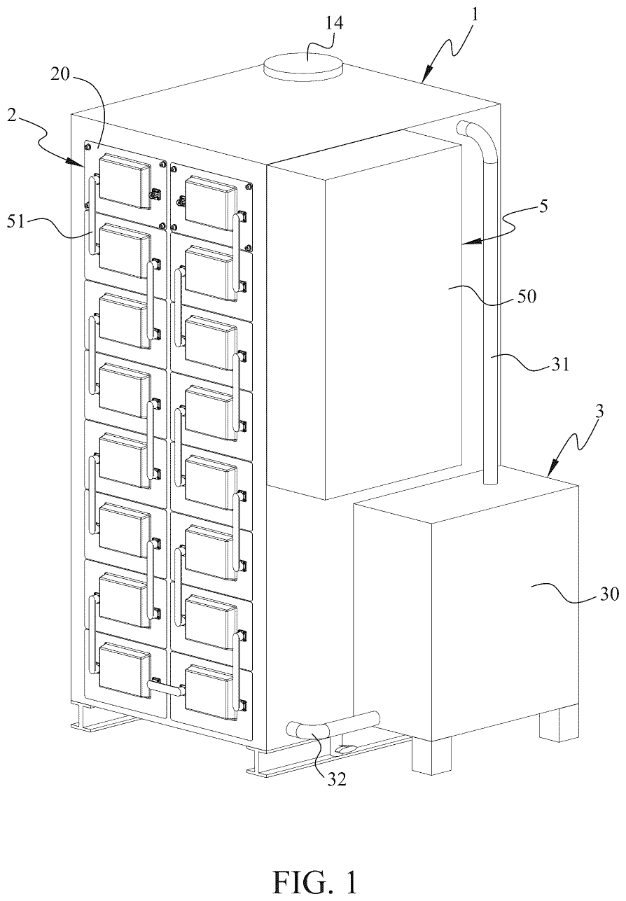

Please refer to FIGS. 1, 2 and 3. A temperature control system for energy-storage battery according to a first embodiment of the present invention includes a fluid storage cabinet 1, a plurality of battery modules 2, a temperature control module 3, a temperature control liquid 4, and a circuit control module 5. It is noted the present invention is also briefly referred to as the energy-storage battery temperature control system or the temperature control system herein for the purpose of conciseness. As shown, the fluid storage cabinet 1 includes a plurality of front openings 10, which extend parallelly rearward to define a storage compartment 11 each, such that the fluid storage cabinet 1 is divided into a plurality of storage chambers 12 arrayed into a matrix and a liquid circulation space 13 not communicable with the storage chambers 12.

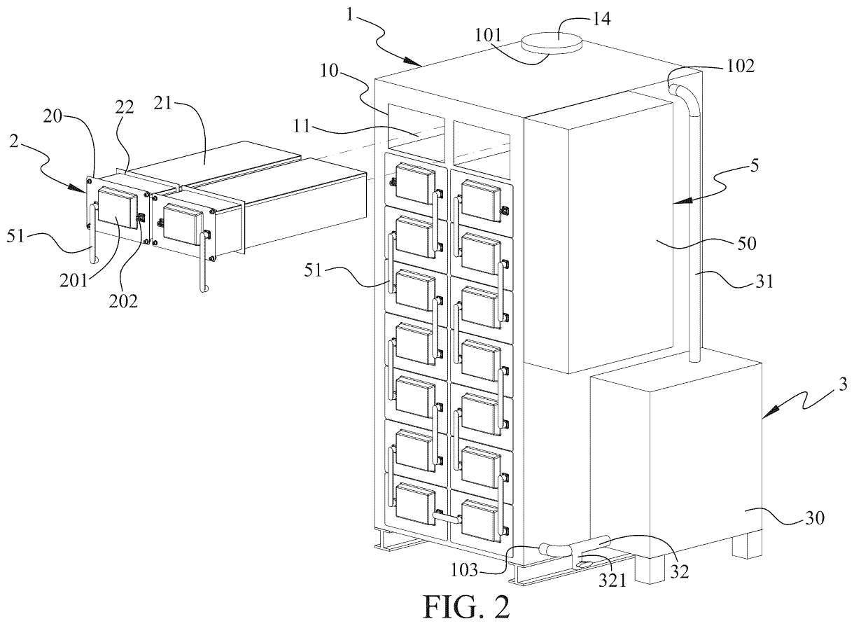

As shown in FIG. 2, the fluid storage cabinet 1 is provided at a top with a liquid replenishing port 101, at an upper location with a liquid inlet 102, and at a lower location with a liquid outlet 103. All the liquid replenishing port 101, liquid inlet 102 and liquid outlet 103 are communicable with the liquid circulation space 13. The liquid replenishing port 101 is openably covered by an upper cap 14. When the upper cap 14 is opened, an amount of the temperature control liquid 4 can be filled into the fluid storage cabinet 1 via the liquid replenishing port 101.

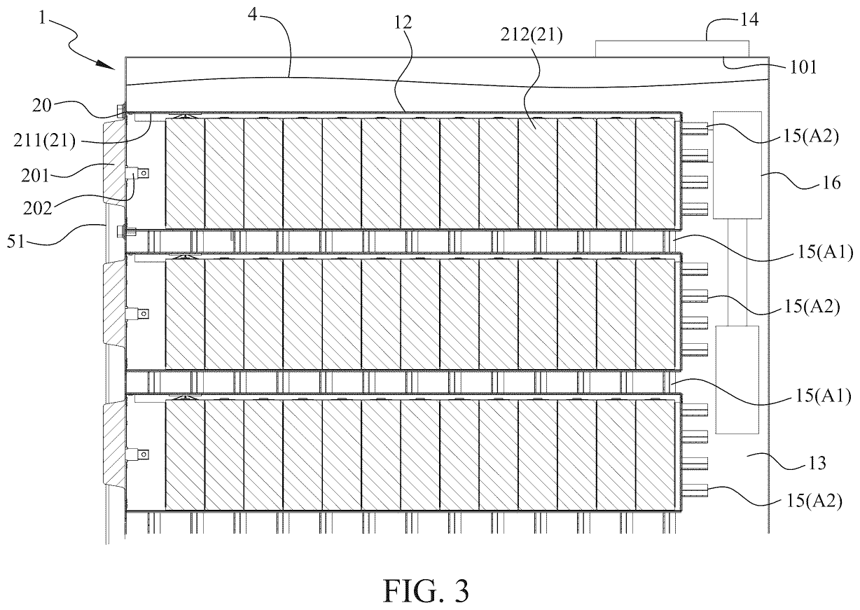

Please refer to FIGS. 2 and 3. Every battery module 2 is removably plugged into one of the storage chambers 12. The battery module 2 includes a closing cover 20 and a battery main body 21. The closing cover 20 has an outer side provided with a circuit pattern 201 and two electrical signal connections 202. The closing cover 20 has a size slightly larger than that of the front opening 10 for covering the front opening 10. The battery main body 21 is connected to an inner side of the closing cover 201 and includes a battery box 211 and a plurality of battery cells 212. The battery cells 212 are connected to one another in series and electrically connected to the circuit pattern 201 and the two electrical signal connections 202.

As shown in FIG. 2, the battery module 2 further includes a leakproof packing 22, which has an inner profile matching that of the battery box 211, such that the battery main body 21 is able to extend from an end through the leakproof packing 22 and allows the leakproof packing 22 to move to another opposite end of the battery main body 21 to press against the closing cover 20.

When the battery module 2 is plugged into the storage chamber 12 via the front opening 10, the leakproof packing 22 is tightly clamped between the closing cover 20 and the fluid storage cabinet 1, such that the storage compartment 11 is sealed to form a closed space and the battery main body 21 is in contact with all conductive wall surfaces in the storage chamber 12. In the illustrated first embodiment, the battery main body 21 is in contact with an upper, a lower, a left, a right, and a rear conductive wall surface, so that heat produced by the battery main body 21 can be dissipated via the five large-area conductive wall surfaces.

Please refer to FIGS. 1 and 2. The temperature control module 3 includes a temperature controller 30, an input pipe 31, and output pipe 32. The temperature controller 30 is installed on an outer surface of the fluid storage cabinet 1, the input pipe 31 is connected to between the liquid inlet 103 and the temperature controller 30, and the output pipe 32 is connected to between the liquid outlet 103 and the temperature controller 30, such that the temperature module 3 is communicable with the liquid circulation space 13. Further, the output pipe 32 includes a drain pipe 321 communicable with an external location.

After the temperature control liquid 4 is filled into the fluid storage cabinet 1 via the liquid replenishing port 101, the temperature control liquid 4 sequentially flows through the liquid circulation space 13, the input pipe 31, the temperature controller 30, and the output pipe 32. When the energy-storage battery temperature control system of the present invention operates, the temperature control liquid 4 flows through the temperature controller 30 and undergoes a heat exchange in the temperature controller 30 to reach a first temperature, and the temperature control liquid 4 undergoes another heat exchange in the fluid storage cabinet 1 to reach a second temperature. Finally, the temperature control liquid 4 flows into the temperature controller 30 again to exchange heat thereat to reach the first temperature again.

In an operable embodiment, the fluid storage cabinet 1 is mounted in a normal environment and the temperature controller 30 is a cooler, and the first temperature is in a low temperature state about 4 to 10° C. On the other hand, when the temperature control liquid 4 flows through the fluid storage cabinet 1, its temperature is changed from the first temperature of a low temperature state to the second temperature of a high temperature state about 40 to 80° C. In another operable embodiment, the fluid storage cabinet 1 is mounted in a cold environment and the temperature controller 30 is a heater. In a further operable embodiment, the temperature controller 30 is equipped with both a cooler and a heater, so that the temperature control module 3 selectively executes a heating procedure or a cooling procedure depending on different environmental conditions.

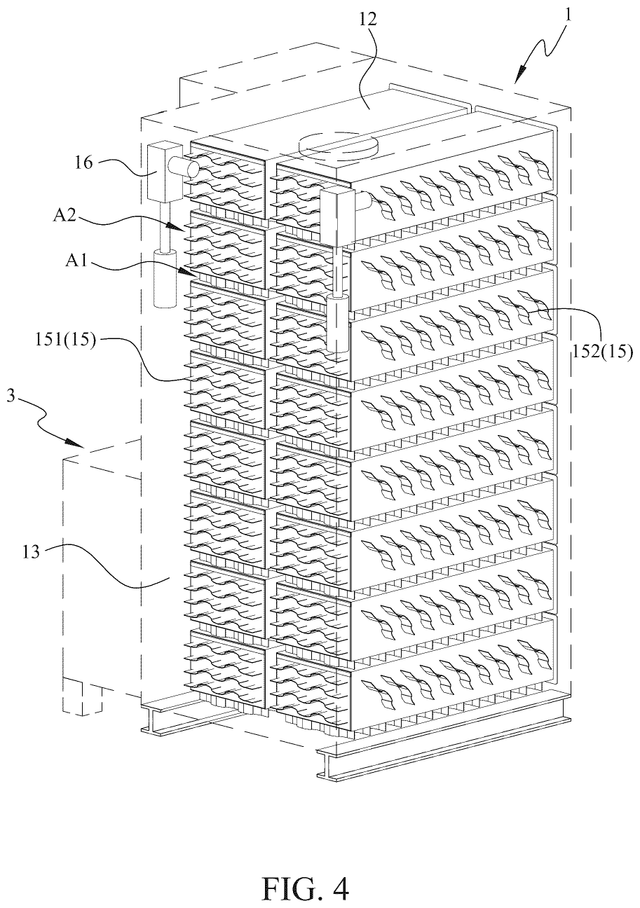

Please refer to FIGS. 3 and 4. The liquid circulation space 13 in the fluid storage cabinet 1 further includes a plurality of radiating fins 15 and a circulation pump 16. The radiating fins 15 are separately provided on outer surfaces of the storage chambers 12 to provide increased heat dissipation areas. The circulation pump 16 is installed at an upper location in the liquid circulation space 13 for changing a flow speed of the temperature control liquid 4.

In a preferred embodiment, the radiating fins 15 are arrayed in the liquid circulation space 13 to form a flow passage, so that the temperature control liquid 4 in cooperation with the flow passage and the circulation pump 16 can form a swirling flow in the liquid circulation space 13.

As shown in FIGS. 3 and 4, the radiating fins 15 have a first part that is distributed between any two adjacent storage chambers 12 to form a plurality of supporting spoiler zones A1; and a second part that is distributed on sidewall surfaces of the storage chambers 12 to form a plurality of guiding spoiler zones A2. The guiding spoiler zones A2 and the supporting spoiler zones A1 are arranged alternately to form the flow passage.

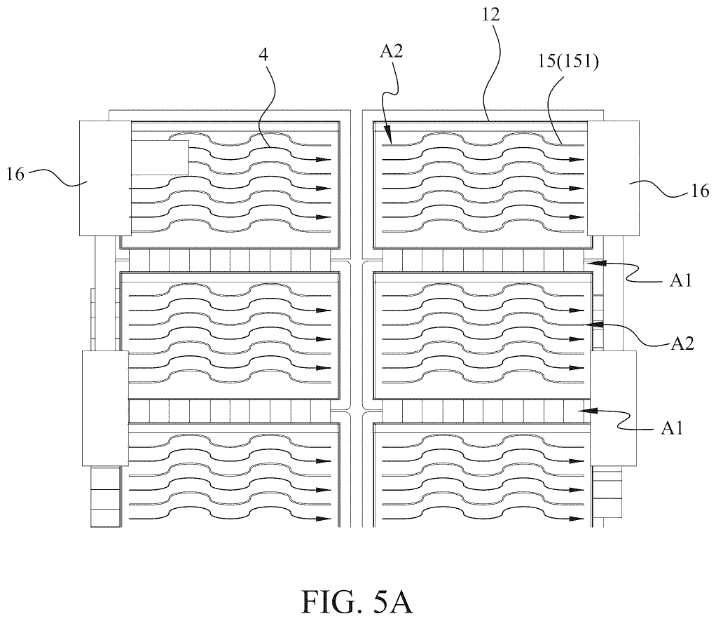

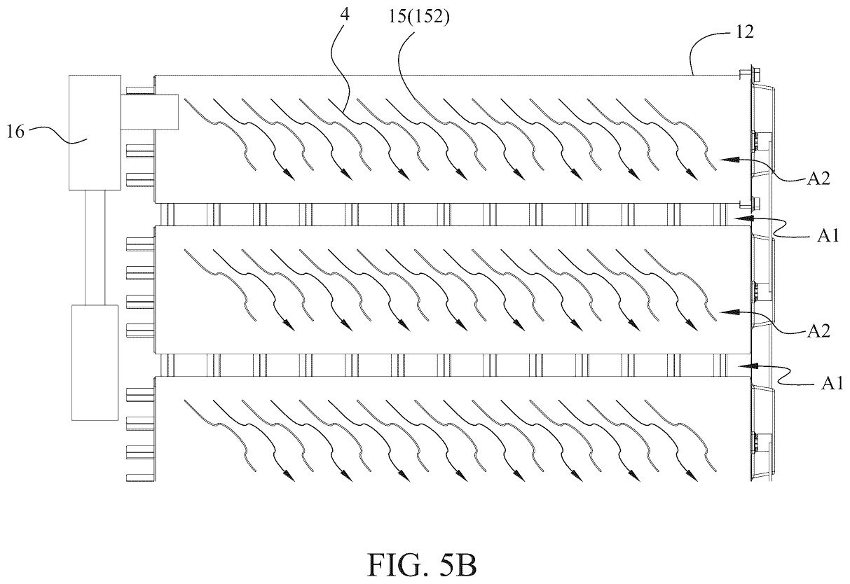

As shown in FIGS. 5A and 5B, every guiding spoiler zone A2 has a plurality of horizontal radiating fins 151 and a plurality of oblique radiating fins 152 distributed therein. The temperature control liquid 4 flows horizontally among the horizontal radiating fins 151, as shown in FIG. 5A, and changes to flow obliquely when it flows through the oblique radiating fins 152, as shown in FIG. 5B.

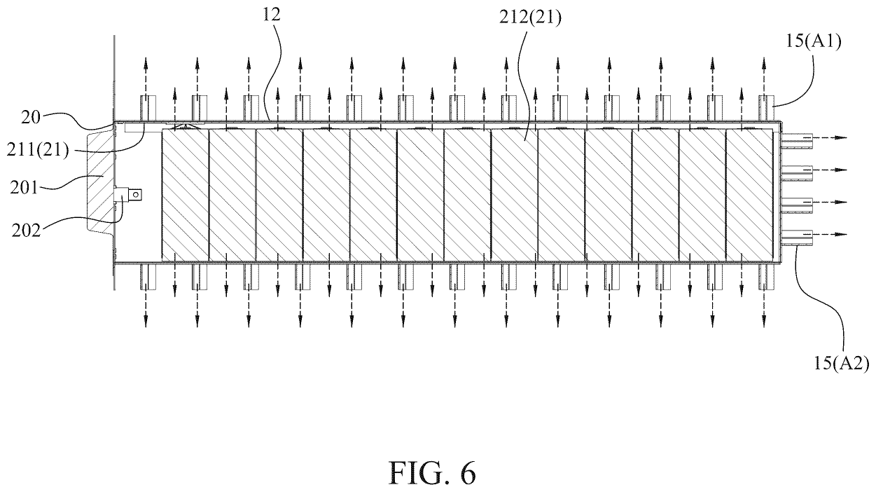

Please refer to FIG. 6. In an operable embodiment, the storage chambers 12 respectively have five conductive wall surfaces, i.e., an upper, a lower, a left, a right, and a rear wall surface. Each of these five conductive wall surfaces has a plurality of radiating fins 15 provided thereon. Therefore, the heat produced by the battery main bodies 21 can be carried away by the temperature control liquid 4 not only when the temperature control liquid 4 exchanges heat with the five conductive wall surfaces of the storage chambers 12, but also when the temperature control liquid 4 exchanges heat with the radiating fins 15. However, it is understood the embodiment in FIG. 6 is only illustrative to facilitate explanation of the present invention. That is, the radiating fins 15 can be provided on one or more of the five wall surfaces of the storage chambers 12.

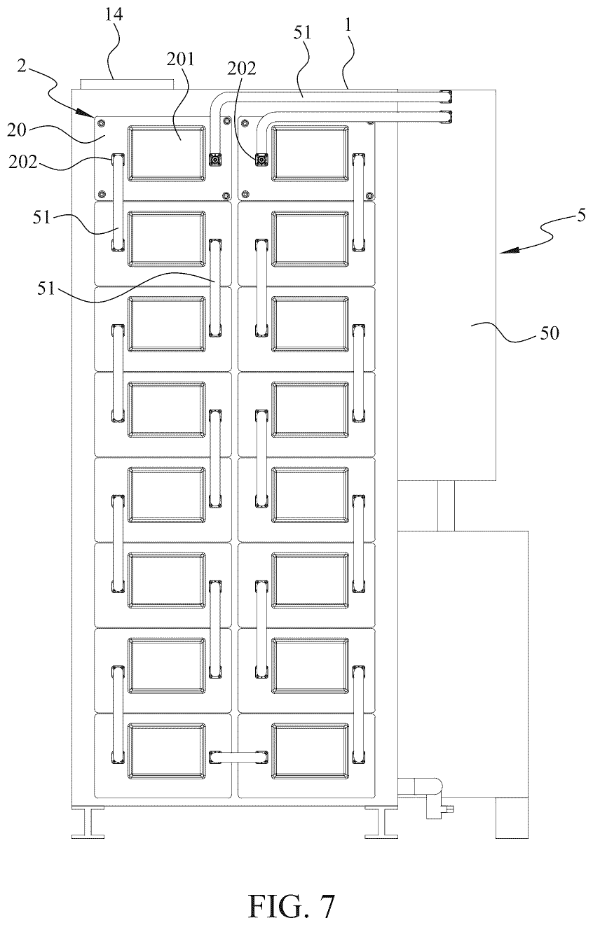

Please refer to FIG. 7. The circuit control module 5 is installed on the fluid storage cabinet 1 and includes a control box 50 and a plurality of conductors 51. The control box 50 and the temperature control module 3 are fixedly mounted on the same side surface of the fluid storage cabinet 1. Two of the conductors 51 are connected to between the control box 50 and two electrical signal connections 202 on two of the battery modules 2, while all other conductors 51 are respectively connected to between two electrical connections 202 provided on two adjoining battery modules 2. With these arrangements, the control box 50 is electrically connected to a plurality of battery modules 2.

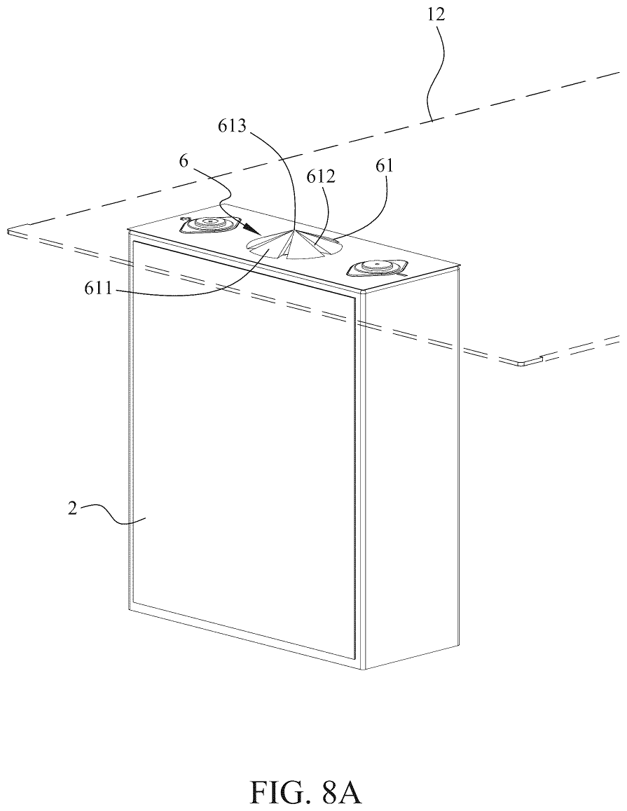

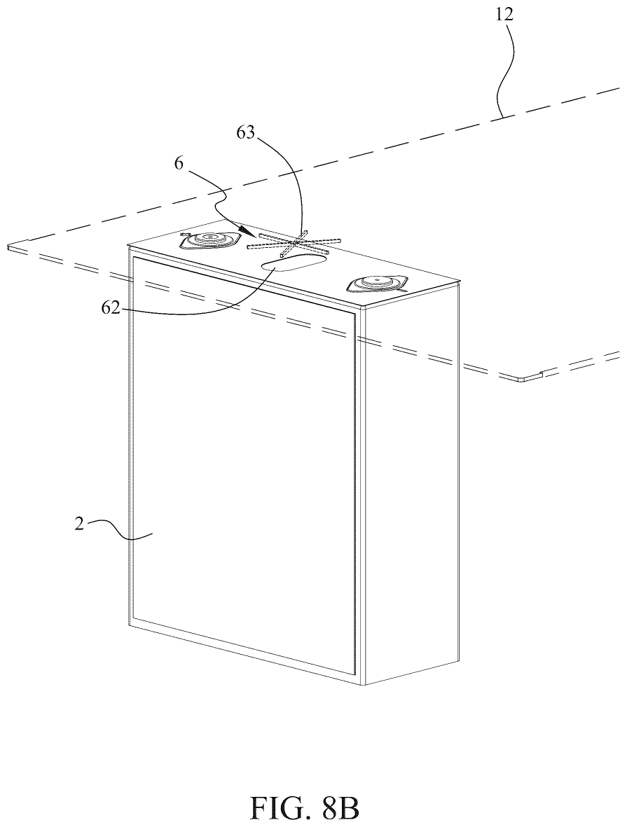

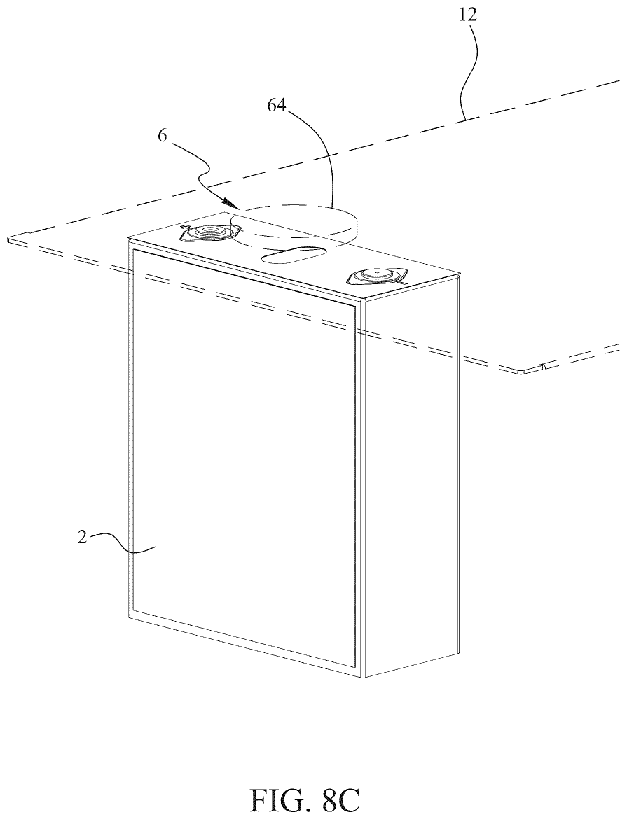

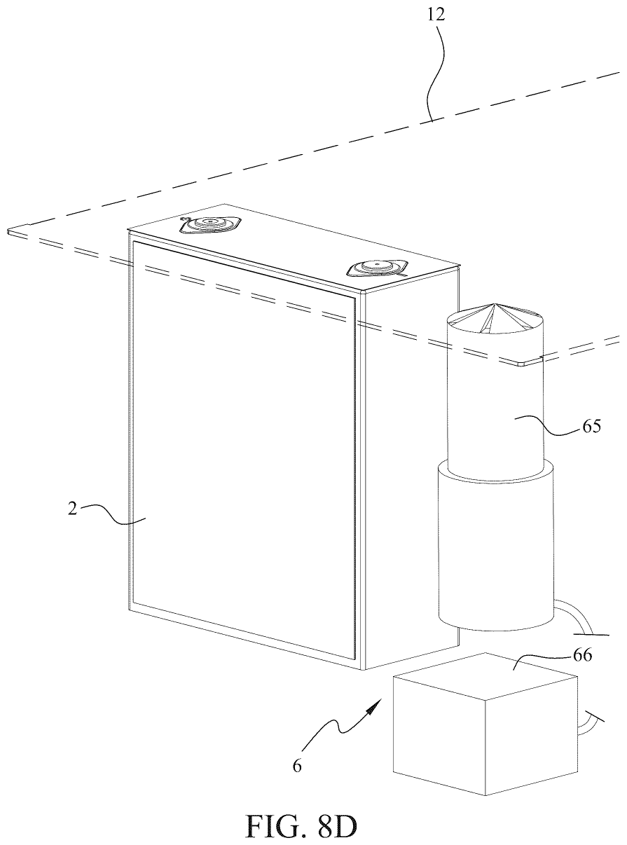

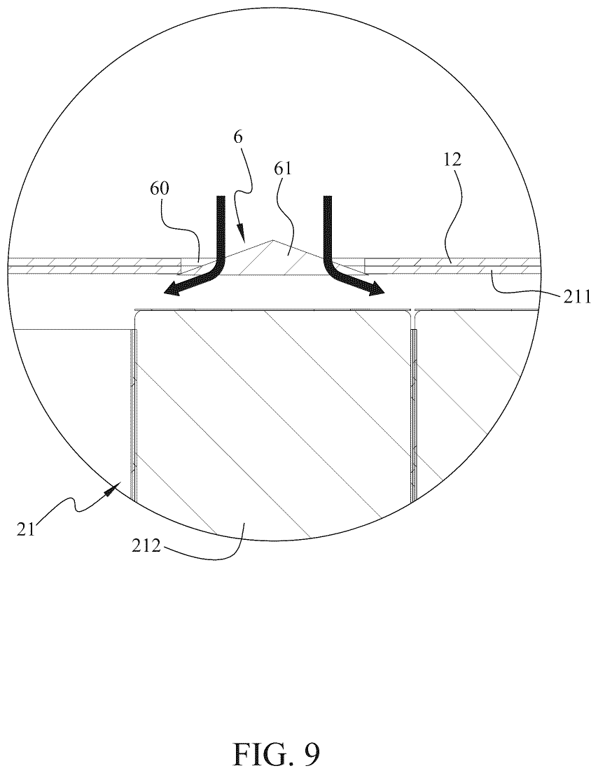

Please refer to FIGS. 8A to 8D and FIG. 9 at the same time. The energy-storage battery temperature control system further includes a plurality of breaking devices 6, each of which is provided on at least one of the storage chamber 12 and the battery module 2 for breaking one of the conductive wall surfaces of the storage chambers 12, allowing the temperature control liquid 4 to flow from the liquid circulation space 13 into the storage compartments 11 to contact with the battery modules 2 and inhibit thermal runaway of high temperature battery. In an operable embodiment, the breaking devices 6 respectively form a liquid-in hole 60 on the upper conductive wall surface of the storage chambers 12, as shown in FIG. 9, such that the storage compartments 11 are completely immersed in the temperature control liquid 4.

In FIG. 8A, there is shown a first operable embodiment of the breaking device 6, which includes a pointed breaking element 61 provided on the battery main body 21. The pointed breaking element 61 is in the form of a cone including a plurality of radially alternately arranged oblique conical sections 611 and a plurality of flutes 612 respectively located between two adjacent oblique conical sections 611 to together define a piercing point 613 on the top of the cone-shaped pointed breaking element 61. When the battery main body 21 bursts out an amount of electrolyte in the event of battery cell abnormality, the pointed breaking element 61 is pushed by the erupted electrolyte against the conductive wall surface to break the latter and accordingly, form the liquid-in hole 60 on the conductive wall surface of the storage chamber 12. Thereafter, the temperature control liquid 4 would flow into the storage chamber 12 via the liquid-in hole 60 and the flutes 612.

In FIG. 8B, there is shown a second operable embodiment of the breaking device 6, which includes a sealing cap 62 disposed on the battery main body 21 and a slitted weak wall portion 63 formed on the storage chamber 12. When the battery main body 21 bursts out an amount of electrolyte in the event of battery cell abnormality, the sealing cap 62 and the slitted weak wall portion 63 would be molten by the erupted high-temperature electrolyte to form the liquid-in hole 60 on the conductive wall surface, allowing the temperature control liquid 4 to flow into the storage chamber 12 via the liquid-in hole 60.

In FIG. 8C, there is shown a third operable embodiment of the breaking device 6, which includes a liquid-in hole 60 formed on the storage chamber 12 and an isolating element 64 for sealing the liquid-in hole 60. When the battery main body 21 bursts out an amount of electrolyte in the event of battery cell abnormality, the isolating element 64 is pushed by the erupted electrolyte away from the liquid-in hole 60, allowing the temperature control liquid 4 to flow into the storage chamber 12 via the liquid-in hole 60.

In FIG. 8D, there is shown a fourth operable embodiment of the breaking device 6, which is disposed inside the storage chamber 12 and includes a piercing member 65 and a sensor 66. The piercing member 65 and the sensor 66 are electrically connected to a control circuit (not shown), and the control circuit is further electrically connected to the circulation pump 16. When the sensor 66 detects any abnormality of the battery module 2, the control circuit would activate the piercing member 65 and adjust the power of the circulation pump 16, such that the piercing member 65 is brought to pierce the conductive wall surface of the storage chamber 12 to form the liquid-in hole 60. Meanwhile, the circulation pump 16 is boosted and the temperature control liquid 4 accelerates into the storage chamber 12 to inhibit the battery module 2 from thermal runaway.

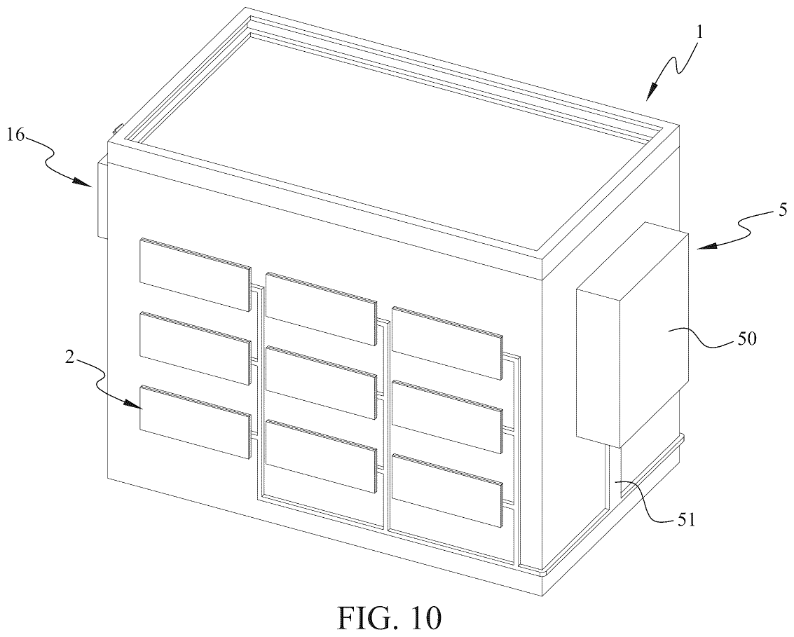

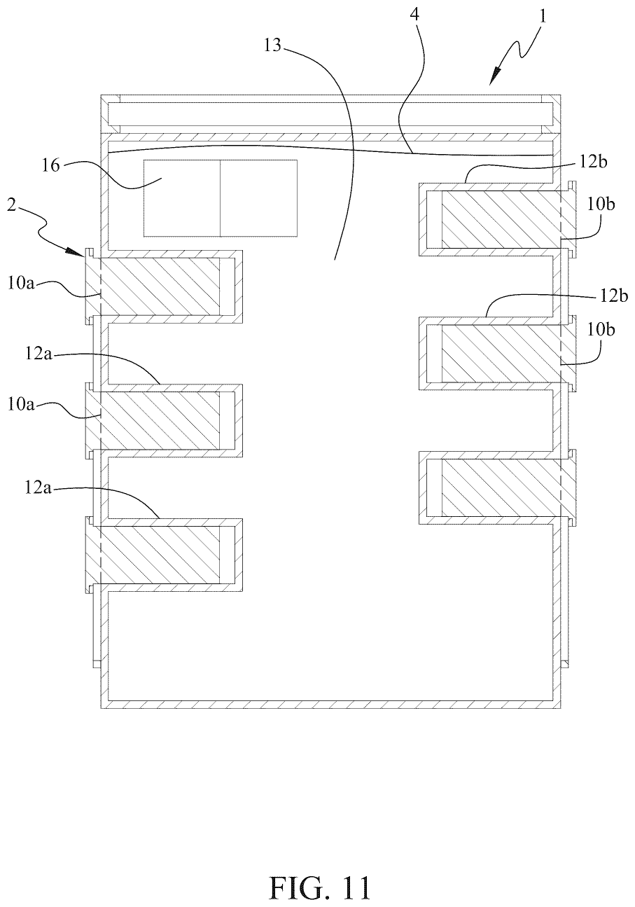

Please refer to FIGS. 10 and 11, in which the energy-storage battery temperature control system according to a second embodiment of the present invention is shown. In the second embodiment, the energy-storage battery temperature control system includes a fluid storage cabinet 1, a plurality of battery modules 2, a temperature control module 3, a temperature control liquid 4 (not shown), and a circuit control module 5. The fluid storage cabinet 1 is formed with a plurality of forward openings 10a and a plurality of rearward openings 10b. The forward openings 10a and the rearward openings 10b are located at positions of different heights, and extend parallelly to respectively define a storage compartment 11, so that the fluid storage cabinet 1 consists of a plurality of front storage chambers 12a arrayed into a matrix, a plurality of rear storage chambers 12b also arrayed into a matrix, and a liquid circulation space 13 that does not communicate with the front storage chambers 12a and the rear storage chambers 12b. As can be seen from FIG. 11, the front storage chambers 12a and the rear storage chambers 12b are so located that there is a height difference existing between them.

As the first embodiment, the fluid storage cabinet 1 in the second embodiment also includes a plurality of radiating fins 15 (not shown) and a circulation pump 16 having the same function as that in the first embodiment. In addition, since the temperature control module 3, the temperature control liquid 4, and the circuit control module 5 are also functionally similar to those in the first embodiment, they are not repeatedly described herein.

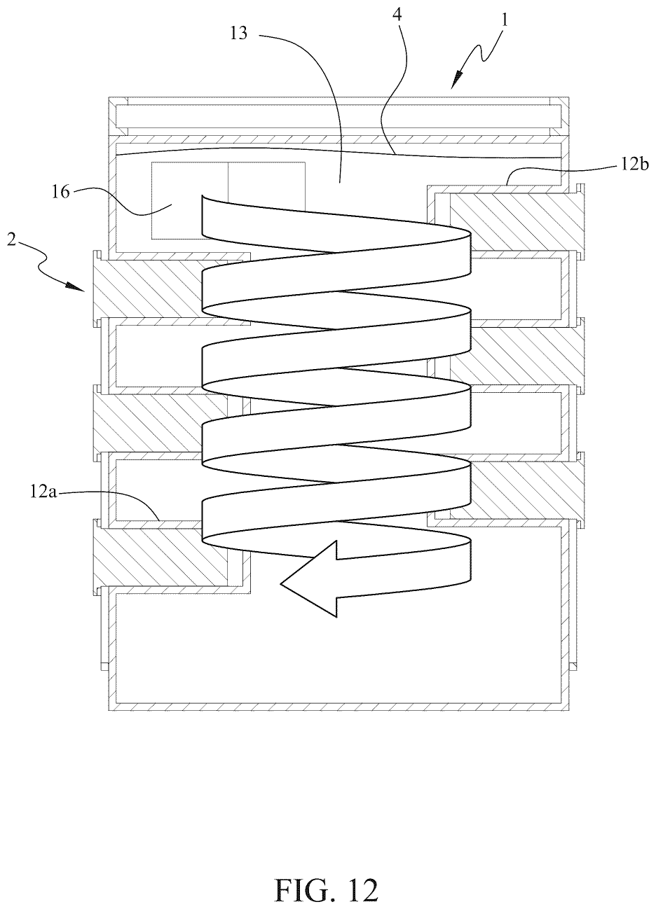

Please refer to FIG. 12. Since there is a height difference existing between the front storage chambers 12a and the rear storage chambers 12b, the temperature control liquid 4 flowing through the liquid circulation space 13 is guided by the radiating fins 15 (not shown) located at different height positions and the circulation pump 16 to form a swirling flow.

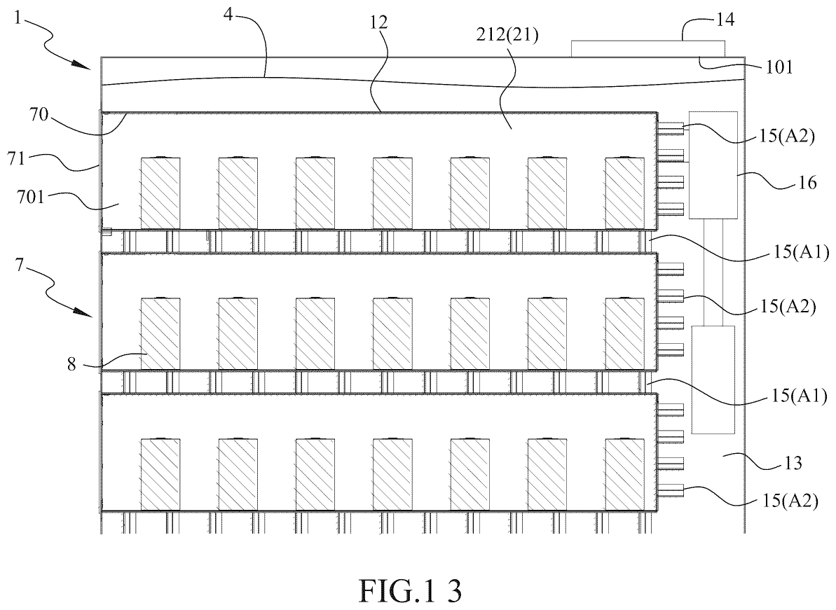

Please refer to FIG. 13, in which a storage system for storing hazardous material according to the present invention is shown. The storage system includes a fluid storage cabinet 1, a plurality of storage modules 7, a temperature control liquid 4, and a plurality of breaking devices 6. The storage system is different from the previously described energy-storage battery temperature control system in three aspects. Firstly, the storage system does not require the circuit control module 5; secondly, the storage modules 7 replace the plug-type battery modules 2; and thirdly, the storage system must include a plurality of breaking devices 6 while the temperature control module 3 is optional and can be selectively installed according to actual need. Under the situation of having not the temperature control module 3, the temperature liquid 4 is stored in the fluid storage cabinet 1 only to serve as an immersion liquid.

As shown, the storage modules 7 respectively include a storage case 70 and a closing plate 71 connected to the storage case 70. The storage cases 70 are respectively removably plugged into one of the storage chambers 12 of the fluid storage cabinet 1 and the closing plate 71 seals the front opening 10. The storage case 70 is in contact with one conductive wall surface in the storage chamber 12, and internally defines a receiving space 701 for selectively receiving at least one hazardous object 8 therein. Since the fluid storage cabinet 1, the temperature control module 3 and the breaking devices 6 are structurally similar to those in the energy-storage battery temperature control system, they are not repeatedly described herein.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A temperature control system for energy-storage battery, comprising:
a fluid storage cabinet including a plurality of front openings and a plurality of storage chambers communicable with and located in one to one correspondence to the front openings, such that the fluid storage cabinet is internally divided into a liquid circulation space and a plurality of storage compartments not communicable with the liquid circulation space;
a plurality of battery modules respectively including a battery main body and a closing cover connected to the battery main body; every battery main body being removably plugged into one of the storage chambers and the closing cover sealing the front opening of the storage chamber, such that the battery main body is in contact with a conductive wall surface of the storage chamber;
a temperature control module including an input pipe and an output pipe communicable with the liquid circulation space, and a temperature controller connected to between the input pipe and the output pipe; and
a temperature control liquid being filled into the fluid storage cabinet to flow through the liquid circulation space, the input pipe, the temperature controller, and the output pipe; and
wherein the temperature control liquid undergoes a heat exchange when flowing through the temperature controller to thereby reach a first temperature, and undergoes another heat exchange when flowing through the fluid storage cabinet to thereby reach a second temperature; and thereafter, the temperature control liquid flows through the temperature controller again to exchange heat thereat and reach the first temperature again.

2. The temperature control system for energy-storage battery as claimed in claim 1, further comprising a circuit control module assembled on an outer surface of the fluid storage cabinet and including a control box and a plurality of conductors; and the storage chambers and the control box being electrically connected by the conductors.

3. The temperature control system for energy-storage battery as claimed in claim 1, wherein the fluid storage cabinet further includes a plurality of radiating fins and a circulation pump; the radiating fins being distributed on outer wall surfaces of the storage chambers to provide increased heat dissipation areas, and the circulation pump being installed in the liquid circulation space for changing the temperature control liquid to different flow speeds.

4. The temperature control system for energy-storage battery as claimed in claim 3, wherein the radiating fins are arrayed in the liquid circulation space to form a flow passage, such that the temperature control liquid in cooperation with the flow passage and the circulation pump form a swirling flow in the liquid circulation space.

5. The temperature control system for energy-storage battery as claimed in claim 4, wherein the radiating fins have a first part that is distributed between any two adjacent storage chambers to form a plurality of supporting spoiler zones, and a second part that is distributed on sidewall surfaces of the storage chambers to form a plurality of guiding spoiler zones; and the guiding spoiler zones and the supporting spoiler zones being arranged alternately to form the flow passage.

6. The temperature control system for energy-storage battery as claimed in claim 1, further comprising a plurality of breaking devices, each of the breaking devices is provided on at least one of the storage chamber and the battery module for breaking one conductive wall surface of the storage chamber, such that the temperature control liquid flows from the liquid circulation space into the storage compartment to contact with the battery modules and inhibit thermal runaway of high temperature battery.

7. The temperature control system for energy-storage battery as claimed in claim 6, wherein every breaking device is adapted to form a liquid-in hole on an upper conductive wall surface of the storage chamber, such that the storage compartment is completely immersed in the temperature control liquid through the liquid-in hole.

8. The temperature control system for energy-storage battery as claimed in claim 6, wherein the breaking device includes a sealing cap disposed on the battery main body and a slitted weak wall portion formed on the storage chamber; the battery main body bursting out an amount of electrolyte in the event of battery cell abnormality, and the electrolyte having a high temperature to melt the sealing cap and the slitted weak wall portion, so that a liquid-in hole is formed on the conductive wall surface for allowing the temperature control liquid to flow into the storage chamber.

9. The temperature control system for energy-storage battery as claimed in claim 6, wherein the breaking device includes a pointed breaking element provided on the battery main body; the pointed breaking element including a plurality of radially alternately arranged oblique conical sections and flutes, and the oblique conical sections and flutes together form a cone with a piercing point; the battery main body bursting out an amount of electrolyte in the event of battery cell abnormality, and the electrolyte pushing the pointed breaking element against the storage chamber to break the conductive wall surface, allowing the temperature control liquid to flow into the storage chamber via the flutes of the pointed breaking element.

10. The temperature control system for energy-storage battery as claimed in claim 6, wherein the breaking device includes a liquid-in hole formed on the storage chamber and an isolating element for sealing the liquid-in hole; the battery main body bursting out an amount of electrolyte in the event of battery cell abnormality, and the electrolyte pushing the isolating element away from the liquid-in hole, allowing the temperature control liquid to flow into the storage chamber via the liquid-in hole.

11. The temperature control system for energy-storage battery as claimed in claim 6, wherein the breaking device is disposed inside the storage chamber and includes a piercing member and a sensor; and the piercing member and the sensor being electrically connected to a control circuit, the control circuit is capable of controlling the piercing member to break the conductive wall surface of the storage chamber.

12. The temperature control system for energy-storage battery as claimed in claim 6, wherein the battery modules respectively include a leakproof packing located between the battery module and the fluid storage cabinet; the leakproof packing being tightly clamped between the closing cover and the fluid storage cabinet when the battery module is plugged into the storage chamber via the front opening, such that the storage compartment is sealed by the leakproof packing and the closing cover to form a closed space, and the temperature control liquid flowed into the storage compartment being stopped from leaking out of the storage compartment via the front opening.

13. A storage system, comprising:
a fluid storage cabinet including a plurality of front openings and a plurality of storage chambers communicable with and located in one to one correspondence to the front openings, such that the fluid storage cabinet is internally divided into a liquid circulation space and a plurality of storage compartments not communicable with the liquid circulation space;
a plurality of storage modules respectively including a storage case and a closing plate connected to the storage case; the storage case being removably plugged into one of the storage chambers of the fluid storage cabinet and the closing plate sealing the front opening; the storage case being in contact with a conductive wall surface of the storage chamber and internally defining a receiving space;
a temperature control liquid being filled into the liquid circulation space of the fluid storage cabinet; and
a plurality of breaking devices being respectively provided on at least one of the storage chamber and the storage module for breaking one conductive wall surface of the storage chamber, such that the temperature control liquid flows from the liquid circulation space into the storage compartment.

14. The storage system as claimed in claim 13, further comprising a temperature control module, the temperature control module includes an input pipe and an output pipe communicable with the liquid circulation space, and a temperature controller connected to between the input pipe and the output pipe; such that temperature control liquid is able to flow through the liquid circulation space, the input pipe, the temperature controller, and the output pipe to undergo a heat exchange.
